(19) United States
(12) Patent Application Publication
(10) Pub. No.: US 2026/0252623 A1
(43) Pub. Date: Aug. 27, 2026

(54) SUPPORTING VISUALLY DESCRIPTIVE TEXT QUERIES

(71) Applicant: Amazon Technologies, Inc., Reno, NV (US)

(72) Inventors: Arnab Dhua, Cupertino, CA (US); Venkata Vijaya Bhargava Punnamaraju, Dublin, CA (US); Vamsi Salaka, Fremont, CA (US); Sameera Ramasinghe, Clarence Park (AU); Thalaiyasingam Ajanthan, Throsby (AU); Sheng-Wei Huang, San Francisco, CA (US)

(21) Appl. No.: 19/062,864

(22) Filed: Feb. 25, 2025

(51) Int. Cl. G06F 16/535; G06F 16/2457

(52) U.S. Cl. CPC G06F 16/535; G06F 16/24578

(57) ABSTRACT

Approaches are disclosed for supporting multi-modal search, including determining when multi-modal search may be beneficial and then prompting the user to use multiple search modalities. In at least one embodiment, a text query entered by a user can be analyzed to determine whether the text query is at least partially visually descriptive of a search target. If so, the user can be prompted to provide another type of search criteria, such as an image representing the search target. The image may be captured or uploaded by the user, selected from a set of recommended images based on the search query, or generated using at least the search query, among other such options. Once provided, the relevant image features can be extracted from the image data and used with the text query to locate relevant search results.

There are various situations—such as for research or online shopping—where a user may use a query that is at least partially text-based to search for content. The content may include various types of digital content, such as information about products available for consumption, articles on a given topic, and the like. When entering a text-based query or set of search terms, users will often provide very descriptive text, which can often relate to multiple visual attributes. This might occur when a user has seen an object in a store or on social media, for example, and is attempting to describe the object based on how the user remembers the appearance of the object. Conventional search indexes include terms that are more objectively associated with given objects (including digital content objects), as may include the type of object, name of the object, physical dimensions of the object, and other aspects that might be provided with the object. The search indexes often will not include visually descriptive terms such as “pretty,” “ornamental,” or “fluffy.” Further, users providing visually descriptive queries tend to use relatively long queries, which reduces the weight given to any objective terms (such as the type of object for which a user is searching) and can result in less accurate search results. Even if other search modalities are available, many users do not know or remember that they exist, do not know how to use them, or otherwise do not know when such modalities are advantageous.

### BRIEF DESCRIPTION OF THE DRAWINGS

Various embodiments in accordance with the present disclosure will be described with reference to the drawings, in which:

FIGS. 1A and 1B illustrate example interface displays that can be used to search for content, in accordance with various embodiments.

FIG. 2 illustrates states of an example interface prompting and allowing a user to provide image data to use for a search, in accordance with various embodiments.

FIG. 3 illustrates states of an example interface that generates and updates an example image corresponding to a text query that can be used to perform a search, in accordance with various embodiments.

FIG. 4 illustrates an example system that can be used to perform multi-modal search, in accordance with various embodiments.

FIGS. 5A, 5B, and 5C illustrate example components that can be used in training one or more models for use with content search, in accordance with various embodiments.

FIG. 6 illustrates an example process that can be performed to detect a visually descriptive query and prompt a user to provide image data to use with a search, in accordance with various embodiments.

FIG. 7 illustrates a network-inclusive computing environment in which aspects of various embodiments can be implemented.

FIG. 8 illustrates example components of a computing device that can be used to implement memory testing and address management aspects of various embodiments.

### DETAILED DESCRIPTION

Approaches described and suggested herein relate to the use of multiple modalities of search criteria when performing a search for content. In particular, various approaches attempt to determine when an additional modality may be useful for a given search, as may be based on an entered text query, then prompt the user to provide such additional information or data. In one example, a text query can be analyzed to determine whether the query has visually descriptive aspects, terminology, or intent. As discussed above, visually descriptive text queries often produce poor quality search results as the search indexes are typically not built using a large amount of visually descriptive terminology. A model such as a lightweight classifier can be used to quickly analyze a query, even as the query is being entered, to attempt to determine whether the query is visually descriptive, or is of a type that could otherwise benefit from an additional type of information. The classifier can be trained using inferences from an intermediate layer of a large language model (LLM), for example, in order to efficiently produce high accuracy inferences for this type of data. If it is determined that the text query can benefit from another type of search criteria, for example, then an interface can prompt a user to provide the additional type of search criteria. This can include prompting a user to capture an image of an object of interest, upload an existing image of the object, select from a provided set of recommended object images, or use and/or update the text query to be used to generate an image of such an object, among other such options. If such image data is provided, that image can be analyzed using an encoder model, for example, to extract relevant image features that can be used along with the text query to perform a search. The text and image features can be transformed to any appropriate format, such as one or more search vectors to be used to search against a vector database or as one or more points in a latent space that can be used to locate relevant content based on proximity in that latent space, among other such options. At least some of the most relevant search results can then be provided for presentation to the user. The user can modify or update the text query and/or image information, or select different objects in the image information, etc., to receive an updated set of search results as appropriate. Such an approach can be used when searching for various types of content through various types of interfaces (e.g., mobile apps, websites, or artificial intelligence (AI) assistants) using various modalities of search criteria.

In the following description, various embodiments will be described. For purposes of explanation, specific configurations and details are set forth in order to provide a thorough understanding of the embodiments. However, it will also be apparent to one skilled in the art that the embodiments can be practiced without the specific details. Furthermore, well-known features can be omitted or simplified in order not to obscure the embodiment being described.

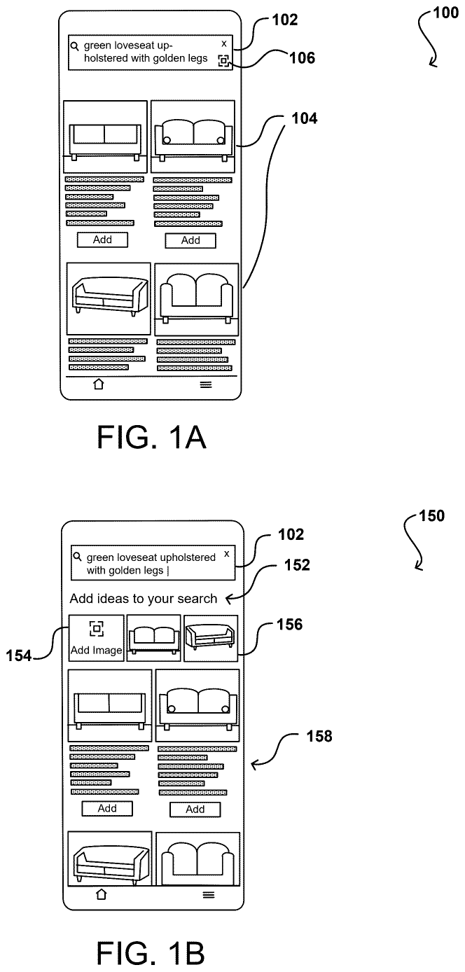

There are various situations in which a user will enter a query or string of keywords to attempt to locate relevant content. For example, a user might enter a query indicating keywords for which a user wants to obtain content, such as an article related to a particular topic or a service manual for a specific product. In many instances, a primarily text-based search works well for such purposes. There may be other instances, however, where a text-based query alone may not be optimal. For example, a user of an electronic marketplace who is searching for a product with a specific look might enter one or more terms and/or a query that is visually descriptive, such as by including one or more visually descriptive terms or using terminology that indicates a visual intent. FIG. 1A illustrates an example interface display 100 of such content and graphical elements, as may be presented via a display screen of a client device, such as a smartphone or tablet computer, among other such options. As illustrated, this example interface display 100 can provide a text box 102 allowing a user to enter a text-based query. The terms of the query can then be used to identify content items 104 determined to be related to the query, such as by comparing one or more terms of the query against a search index for a product database, among other such options. Approaches that can be used to query a data repository using text-based queries are well known, and as such will not be discussed in detail herein.

As illustrated, the query provided by the user provides what may be referred to as a “visual description” of a product of interest. Product databases often index terms that are objectively associated with a given product, such as a product type, size, color, item number, manufacturer, or other such factual/functional term. A traditional search that is likely to locate a specific item might then include a combination of these terms, such as “48 inch Acme reclining loveseat.” Visually descriptive queries, such as “green loveseat upholstered with golden legs” may not function as well, however, as the terms of the query relate more to the visual appearance of the user, which is not only subjective, but often is not comprised of the types of terms that would generally be indexed for a given product based on, for example, its manufacturer-provided description. The identified content items 104 may then not be particularly relevant to the intent of the customer, as there may be no high probability matches based on the use of descriptive terms. And, potentially counterintuitively, trying to make the query more specific by including more descriptive terms may actually negatively impact the relevance of the identified content items, as a visually descriptive query “pretty couch” is still highly likely to return results related to couches, while a visually descriptive query such as “pretty couch with rounded arms and a cushiony back with square legs and a flowery pattern” may return various items with combinations of “flowery patterns,” “square legs,” and “cushiony backs,” such as chairs or beds, as well as unintended combinations of terms such as items with “square backs” and “cushiony patterns,” etc. With additional terms, the weight given to the term “couch” will decrease accordingly.

In at least one embodiment, a user can provide or select an image (or set of images, segment of video, etc.) that can be used to help identify a relevant product of interest. In FIG. 1A, the example interface display 100 includes a selectable graphical element 106 or icon that allows a user to upload or provide an image that provides an example of a type of item or object for which the user is searching. In many instances, however, users may fail to understand the functionality of such an icon or element, or may simply forget that such an option is available. Approaches in accordance with various embodiments can attempt to determine when a user is entering a query or set of text terms that is visually descriptive in nature, and thus could potentially benefit from the addition or inclusion of image data. Upon making such a determination, the example interface display 100 can be updated to more clearly present these options, and to encourage or prompt the user to provide such information if available.

For example, an interface display 150 as illustrated in FIG. 1B can be presented that allows a user to enter one or more text-based search terms and/or a search query into a text box 102 in order to allow for a search for relevant products or content. In addition, the example interface display 150 also includes additional graphical elements that allow the user to enter additional information to use for the search. In this example, the interface includes prompting language 152 to add at least one image, and a first element 154 that allows a user to upload an image of a product of interest, or at least a product that is somewhat visually similar to a product of interest. For example, a user might see a product in a store and might want to access customer reviews of that product. The user might then then capture an image, or upload a previously-captured image, of that item. The example interface also includes one or more elements 156 illustrating images of products identified based in part on the entered query. A user may then select one of these elements if the illustrated product happens to be the product of interest, or is at least similar to the product of interest. In this example, both of the elements 156 illustrate loveseats, so the user may select one of the elements if that element is associated with a loveseat that is visually similar to the product of interest. It should be noted that the product of interest may not be an actual product, but may be a product with a specific visual appearance desired by the user, and the user is looking for the closest available product. If the user had entered a query such as “holiday items” them the elements may be associated with different types of items, such as ornaments or holiday-themed clothing items, and the user may select the element with the most relevant type of item, among other such options. The identified content items 158 that are displayed may be updated with each change in the terms or query entered into the text box 102, as well as any uploaded or selected images, or other such changes in search content. In at least one embodiment, a search will be updated with each such change, and the top ranking (or matching) items to be displayed will be updated accordingly.

Such an approach can be beneficial for any type of content that can be identified based in part upon visual appearance. Highly visual descriptive queries such as “fluffy seating including warm tones and an inviting feel” may be unlikely to result in highly accurate search results, but if a user can also (or alternatively) provide a picture of such seating, then that picture can be analyzed to determine features more likely to result in highly accurate or relevant search results. This may be particularly useful for content such as art, where descriptions can be highly subjective and varying. Such an approach can also be useful for objects such as clothing items where there might be a specific style or “look” of interest, but a query to describe that look might be highly visually descriptive. In some embodiments there may be options to provide other types of content as well. For example, video content (or a set of images) might be uploaded to show an item from various sides or views, or to show how the item moves or flows, such as whether it appears to be made of a light or heavy material. Audio content may be uploaded if there is an audible aspect to the object, such as a noise the material makes or a sound the object produces. Audio content may potentially also be uploaded to provide a verbal description of the item, which may then be analyzed using a language model or other such mechanism to generate an appropriate search query. Other types of content may be provided as well, such as point cloud data, motion data, smell data from an odor sensor, and the like, where that content can provide some descriptive data about an object or item (including an object or item of digital content) that can be useful in locating information about that object or item (or a type of object or item, etc.).

In such an interface, the images suggested may clearly show a specific item. For example, a suggested image may only include a specific object, or may have a view such that the object of interest is centered in the image and take up a significant portion of the image, at least with respect to other objects in the image. When a user uploads an image, however, the object or interest may not be as clear. Similarly, there may be multiple objects of interest in the image. Accordingly, approaches in accordance with various embodiments can analyze an uploaded or captured image and provide indication of the object identified as being the object or interest, and can provide options to select other objects identified in the image. In some embodiments, the interface may instead provide options to select various objects in an image, instead of selecting one by default, as may be based on a confidence or similar value.

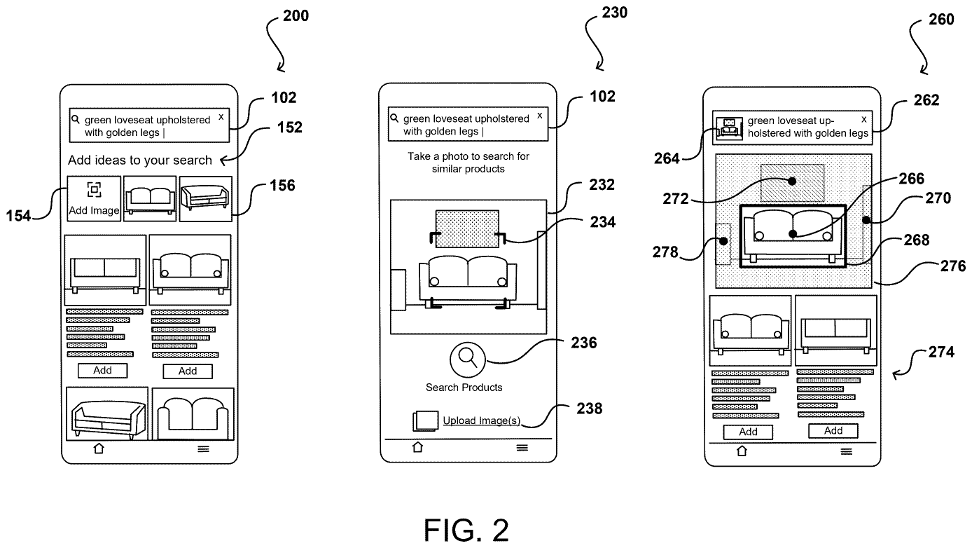

FIG. 2 illustrates states of an example interface that can allow a user to upload an image for use in locating an object of a specific type, or at least having specific visual characteristics. In a first example interface state 200, the user is presented with options as discussed with respect to FIG. 1A, including a graphical element 154 allowing a user to capture and/or upload an image representing an object having one or more visual characteristics of interest. It should be noted that reference numbers may be carried over between figures for simplicity of explanation, but such usage should not be interpreted as a limitation on the scope of various embodiments unless otherwise specifically stated. A second example interface state 230 is illustrated that shows a live camera view 232, such that a user can cause an object of interest to be located (at least partially) within the live camera view 232 and select a capture element 236 to cause the camera to capture an image corresponding to the live camera view 232. In this example, there are guide elements 234 displayed over the live camera view to encourage the user to center the object of interest in the image. While not necessary in at least some embodiments, centering the object of interest and having the object occupy a significant portion of the image can increase the likelihood of that object being identified as the object of interest. A selectable graphical element 238 can also be provided to allow the user to additionally, or alternatively, upload existing images, such as digital images that were previously captured or that were obtained from a third party source, such as a website or received digital message.

Once an image has been uploaded, an interface state 260 can be presented that provides results 274 determined based in part upon the uploaded image. In this example, a thumbnail version 264 of the uploaded image is displayed in (or along with) the text box 262 in order to convey to the user that the uploaded image should be considered part of the search query, along with the provided visually descriptive text. A user can have the option to click on that thumbnail version 264 and delete the image if the user no longer wants that image to be used for the search. There can be other options as well, such as to replace the image, add another image, and so on.

In this example, the uploaded image 276 is displayed along with the search results 274. A bounding box 268 is illustrated as an overlay of the image, where the bounding box surrounds an object (here the loveseat) identified as the object of interest. As mentioned, the object can be identified as the object of interest based on various factors, such as being relatively centered in the image and occupying a significant portion of the image. The object may also be identified based in part upon the provided query (if one was provided), which in this example includes the term “loveseat.” The search results 274 provided will then be based in part upon features extracted for the current object identified in the bounding box 268. In some embodiments, a user may have the ability to adjust the bounding box, such as to represent the actual bounds of an entire object or to focus on a portion of the object that includes a visually important aspect of that object. The user may also be able to move the bounding box to instead focus on another object in the image. Any adjustment to the bounding box can cause a new or updated search to be performed, and updated search results 274 displayed as appropriate.

In this example, there are selectable elements 266, 270, 272, 278 provided with respect to individual objects identified in the image. In the present state, the loveseat is the object of interest so the bounding box 268 is illustrated around the loveseat. The rest of the image outside the bounding box may be grayed, or shown with lower brightness, for example, to further illustrate which object is currently identified as the object of interest. If, however, the user would prefer that another object in the image be selected (either additionally or alternatively) as the object of interest to use for a search, the user can select one of the selectable elements 270, 272, 278 associated with that object. The interface can then attempt to add or adjust a bounding box to surround that particular object, and can adjust the brightness for one or more portions of the image to better identify the currently-selected object(s) of interest. With each such adjustment, a new or updated search can be performed and results 274 updated as appropriate.

In some instances, a user may not have (or be able to capture) an image of an object of interest. For example, the user may be searching for something they have seen previously but for which they did not capture an image. In other instances, a user may have an object in mind that the user has not actually seen—such as a piece of furniture with a specific combination of features or visual aspects that the user desires but may have never actually seen in a single object. In at least one embodiment, a generative process can be used to generate an image of an object that the user describes, in order to ensure that the description is being interpreted properly, and giving the user an ability to adjust the description as appropriate.

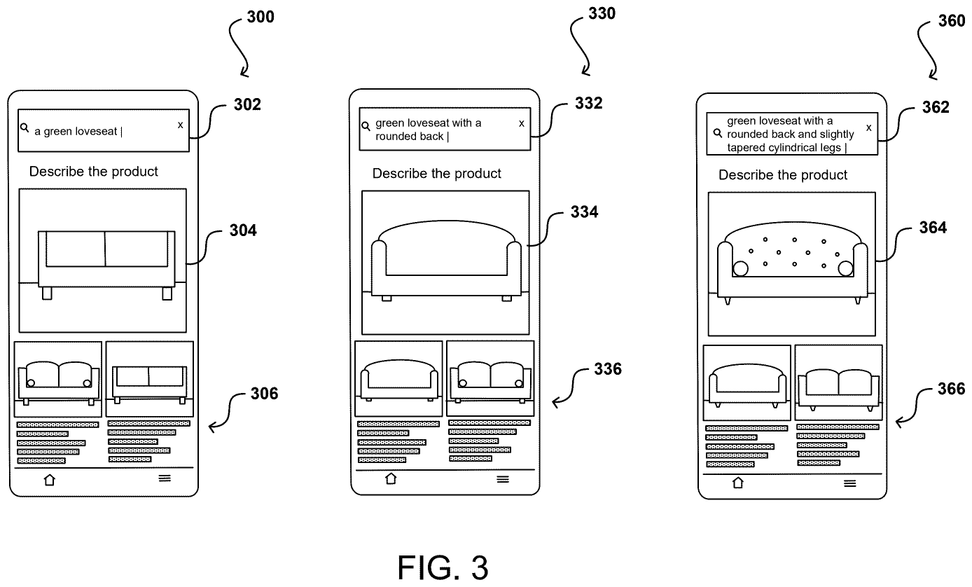

For example, FIG. 3 illustrates an interface that provides a view of a synthetic image that is generated based at least in part upon text provided by the user in a search query (or through captured speech or another such input method). In this example, the generated image can potentially be updated (or a new image generated) with each update (e.g., addition, deletion, or replacement of a term) of the query. In a first interface state 300, the user has entered the partial query “a green loveseat.” In some embodiments such an interface may provide the generated image automatically or as selected by a user, or may present such an image when a query is identified as being visually descriptive, among other such options. At least the terms “green” and “loveseat” can be passed to a generative process, as may include a generative artificial intelligence (AI) model, to generate an image of an object matching those terms. The generated image 304 displayed can then include an example of a green loveseat. A set of search results 306 can be displayed that are based at least in part on visual features of the object in the generated image 304, as well as potentially terms in the provided query in the search box 302, among other such options. If the generated image does not include one or more visual aspects of interest to the user, for example, the user can add terms to the query, or modify the query, in order to better specify those visual aspects. For example, in a second interface state 330, the user has added the terms “with a rounded back” to the query in the test box 332. In response, a new synthetic image 334 can be generated based further on the additional terms, and that new synthetic image 334 can be presented to the user. An updated search can also be performed based in part upon visual aspects of the object in the new synthetic image 334, and updated search results 336 presented as appropriate.

The user can continue to modify the query in the text box 362 (or as otherwise provided) until the object in the generated image includes the desired visual aspects, for example, or until the displayed search results 366 include the visual aspects or are at least determined to be of interest to the user, among other such possibilities. In this example, the user has added the terms “and slightly tapered cylindrical legs” to the query, which has caused another new synthetic image 364 to be generated that represents an object having those aspects. As illustrated, modifying one aspect of the object may result in modifying other aspects of the image as well, as a change in style may impact other portions of the object. As mentioned, the user can continue to modify the query as appropriate, changing an inclusion or description of one or more visual aspects. In some embodiments, a weighting of the features of the generated image may be greater than that of the entered query terms, although such weighting may be configurable and may depend in part upon aspects such as the type of object or aspect(s), types of terms used in the query, and so on. Individual terms in the query might be weighted differently as well, as an object-specific term such as “loveseat” may be weighted more than a visually descriptive term such as “rounded,” and so on.

Once such a synthetic image is generated, it can be added to an image repository for future use, at least when such an image was determined to include the aspect(s) of interest. This may include, for example, surfacing the image as a recommended image when a user inputs a query that is determined to have at least some similarity in visually descriptive terminology. The selection of (or interaction with) such synthetic images may be tracked, and the data used for various purposes. For example, if a synthetic image is selected with at least a minimum frequency or a minimum number of occurrences, that image might be provided to an entity that markets, purchases, or manufactures that type of item. A provider of an electronic marketplace might then ask a vendor to produce such an item, or may attempt to locate a vendor from which such an item (or a similar item) may be purchased or sourced. A manufacturer receiving such information might determine itself to produce such an item, and potentially related items with similar visual aspects (e.g., a chair and loveseat that go with a popular couch represented in a synthetic image). A marketing person might use that image and build a marketing image or campaign that includes a representation of the virtual item, or may use that as motivation to design a campaign that includes a similar visual appearance or style. There may be various other advantages obtained from being able to determine a type of item that users or customers desire, but may not yet be available (or is only available from other sources). In some embodiments, an entity might also test potential designs by surfacing synthetic images showing those designs, and measure the response to those designs before going into production or making purchases of those items. It might also be the case that each synthetic image is stored to an interest repository that can be reviewed to attempt to better understand current trends, customer interests, and the like.

In some embodiments, where it is determined that a multi-modal search may produce more accurate or useful search results, at least one additional type of data may be generated and used automatically, whether or not that additional data is surfaced to the user. For example, referring again to FIG. 3, a user might enter a visually descriptive query of an item. Instead of prompting the user to trigger generation of a synthetic image representing the item understood from the query, the synthetic image data may be generated automatically. This synthetic image data can then be used with the text query to perform a multi-modal search. The synthetic image may automatically be displayed to the user as well, in a way that is associated with the query, so the user can make changes as appropriate. It might be the case, however, that the image data is only used to attempt to improve the search results, and is not surfaced to the user. A generative AI model might produce highly accurate images when analyzing visually descriptive queries, particularly if the AI model is at least partially language based or works with a large language model, for example, and is able to translate a visual intent or description into a realistic image that will improve search results. Other types of data, such as audio or animation, may be generated as well for similar purposes.

As mentioned, such an approach can allow a user to provide, capture, select, and/or generate one or more images of an object having one or more visual aspects of interest, which can be used to better identify objects or content having, or associated with, the one or more visual aspects of interest. This can be particularly beneficial when a query is provided that attempts to capture the one or more visual aspects using visually descriptive language, which may not produce particularly relevant results when searching against a search index including more objective terms that may be used to describe properties or aspects of an object.

In at least one embodiment, reminding a user of the ability to provide an image as part of a search, or prompting a user to provide or select such an image, can be performed in response to identifying a query as including one or more visually descriptive terms, or determining an overall query to have at least a threshold probability of being at least partially visually descriptive. This can include analyzing the terms of the query as they are entered (through typing, voice entry, or another such input mechanism) so that the reminder can be provided as quickly as possible. Providing such a reminder early in the query entry process can avoid the user having to enter a lengthy query, which can conserve energy and processing time, and can further conserve computing resources by allowing for more accurate search results to be presented based in part upon the image data, which avoids further search iterations.

In at least one embodiment, a fast classifier can be used that takes a text query as input, and predicts whether the query has (explicit or implicit) visual intent, or is at least partially visually descriptive. Such a classifier may need to be relatively lightweight and fast, such as to make classifications on the order of a few milliseconds or less, in order to avoid undesirable delays or additional latency added to the search process. In at least one embodiment, a classifier can work with, or as part of, and autocomplete process for a query, such as to present an ingress to add an image in the autocomplete suggestions. Such a process can analyze other signals as well, such as whether a user pasted in search text, or typed several words as features to such a classifier. If a classifier process infers a strong visual intent or descriptiveness to a query, then in addition to prompting a customer to enter (or select, capture, or generate) an image, the system can also provide images (e.g., third party images or “influencer” images) that are determined to at least partially match the text that was entered. In some embodiments, use of a classifier may introduce an unacceptable amount of latency, or may be too resource-intensive. In such instances, an algorithm-based pipeline can be used to analyze a query and make a determination as to whether the query could benefit from a multi-modal search and/or at least one additional type of information. This may include, for example, identifying that the query includes one or more terms that have been found to frequently produce suboptimal results, and then determining to prompt for additional information to attempt to improve the results using a multi-modal search.

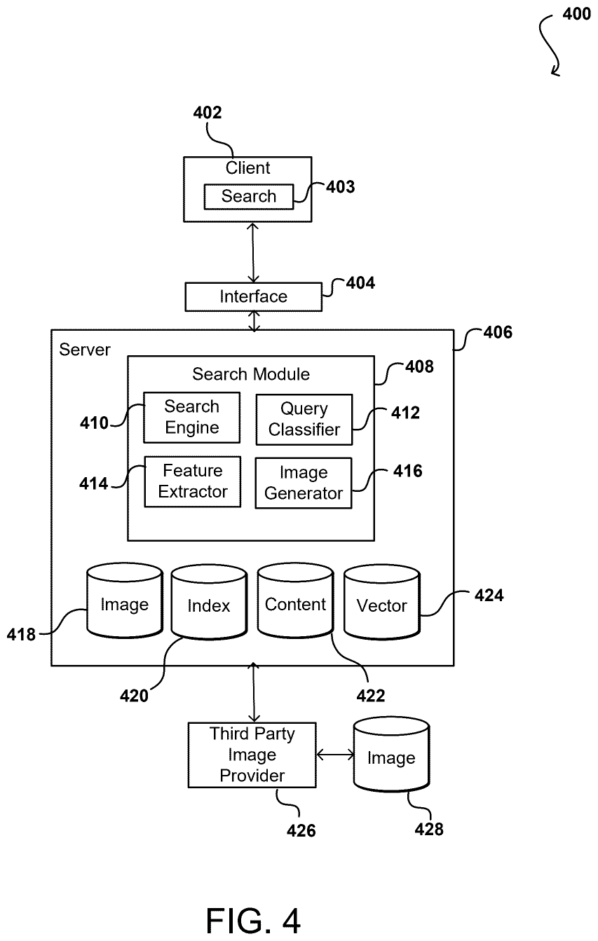

FIG. 4 illustrates an example system 400 that can be used to perform tasks such as to identify visually descriptive queries, prompt a user to provide image data along with the query, extract visual features from the image data, and provide search results based in part on the image data in accordance with at least one embodiment. In such a system, a user can use a client device 402 running a search application 403 (or displaying a search interface, such as through a webpage in an Internet browser) to submit queries that are transmitted to a search server 406 to locate a set of search results relevant to the query. The query (or information associated with the query) can be directed to an appropriate interface or address of an interface layer 404, then directed to the appropriate search server 406. As discussed herein, the search server 406 may be a physical or virtual server or compute instance, among other such options. The server 406 can run a search module 408, which can include (or work with) various sub-modules that can perform various tasks related to search. This can include, for example, a search engine 410 that is able to perform a search using search criteria such as keywords, latent embeddings, feature vectors, and the like. The search engine 410 can perform the search against a search index 420 or vector database 424, among other such options. Once a set of matching content items is identified, content for those items can be retrieved from a content database 422 or other such location, and provided for display via the client device 402.

In this example system 400, a query entered by a user may be transmitted to the server during entry of the query, for example, and at least some of the query terms (minus any stop words or articles, etc.) may be provided to a query classifier 412. The query classifier 412 can be a trained classifier model or language-based model, for example, that can determine whether the query has at least a minimum probability of being visually descriptive, or including visual descriptive aspects or intent. If so, instructions can be sent to the search application 403 to prompt the user to upload, select, provide, or generate image content representative of the visually descriptive aspect(s) of interest. As mentioned, images matching the query may be selected from an image database 418 and provided as potential selections. These images may come from the content repository 422 or from an image database 428 of a third party image provider 426, among other such options. As mentioned, an image generator 416 such as a generative AI model can be provided that can enable synthetic images to be generated based in part upon the query entered by the user, in order to allow the user to modify the query to cause the image to represent an object with the specific visual aspect(s) of interest. Once at least one such image is provided, uploaded, selected, or generated, that image can be passed to a feature extractor 414, such as may use an AI-based encoder module to extract relevant image features and embed those features as points in a latent space or one or more feature vectors, among other such options. These embeddings or feature vectors, along with the text-based query, can be used by the search engine 410 to attempt to identify relevant search results to present to the user. As mentioned, these search results can be updated as appropriate due to changes in the query, image(s), or image element selections. When a user selects a search result, content for that result can be retrieved from the content repository 422, or other such location, for presentation via the client device 402.

In at least one embodiment, there can be multiple signals used to predict, for example, that a user has a strong visual intent or that the user is looking for a product from a competitor's website. This includes, for example, pasting in five or more words into a text search bar, rather than manually typing in or speaking those terms. If a search application has access to information indicating whether a user used a paste function, such a determination can be straightforward. If access to such information is not available, then another determination can be made to attempt to determine how quickly the words were typed. For example, if a given search application sends a query update after entry of each term, but the terms of a query were all entered within less than a threshold amount of time reasonable for manual entry, then a determination can be made that the paste function (or a similar entry operation) was used. Such examples provide mechanical ways to obtain an intent signal, for use by a search engine 410 to identify relevant search results. Such a system can also analyze the text that was entered as a query or set of search terms, and can attempt to identify certain patterns. Such patterns can include, for example, two or more visual attribute terms in a category where visual concepts are indicated to be important. Such categories may include, for example, apparel, art, home, clothing, or furniture-related categories. In at last some embodiments, the length of a query can be indicative of a descriptive query, such that it may be beneficial to prompt a user (through an autocomplete module or otherwise) to upload an image along with the query.

An AI-based model can be trained to classify an input user query, among other such text-based inputs. A large language model (LLM) can provide an accurate mechanism for inferring whether a given query is visually descriptive, or includes visually descriptive aspects or intent. As mentioned, however, for live search interactions it can be desirable to keep the query analysis as quick as possible. While LLMs are highly accurate in many instances, they are relatively large and take a while to process, such that their applicability for query classification may be limited in such situations that may have critical latency requirements. This may be of particular concern in various embodiments where the model has to be integrated with the text search infrastructure.

In order to avoid the need to use an LLM, a system in accordance with at least one embodiment can use a model that is effectively LLM-based. An LLM can be trained and fine-tuned on relevant training data. Some care should be taken generating the training data, as exact word-to-word match may not be ideal in at least some situations. The knowledge of that LLM can then be distilled into a smaller model, such as a lightweight transformer model. This can include, for example, generating highly accurate classification of queries using the LLM, the using the classifications and corresponding queries as training data to train the transformer model, so that the transformer model can generate similar high-quality inferences to the LLM on this type of data, but in a much faster and lightweight manner. In at least one embodiment, dedicated libraries and engineering methods can be used to speed the inference to near real time. In at least one embodiment, the training process can regress not to the final output of the LLM but instead to an intermediate output. This can include taking into account the actual probabilities of the SoftMax layer generated before the final layer generates a single output value, such as a probability of a given classification. Such intermediate values can be used as soft labels that provide more insight into the actual behavior or learning of the LLM. If training were instead performed on only the final output, the lightweight classifier would learn its own internal structure instead of replicating the relevant internal structure of the LLM. Such improvements could include, for example, model quantization and hardware specific optimizations using middleware libraries (e.g., ONNX or TensorRT). In a test example, a training process used the annotated queries by the LLM to train a distillBERT-based classifier which has been shown to achieve 92% accuracy while running 60% faster and being 40% lighter. To this end, a classification head was added on top of distillBERT pre-trained embeddings and a binary classification module trained. With this, a 78% accuracy was achieved with an inference time was around 200 ms.

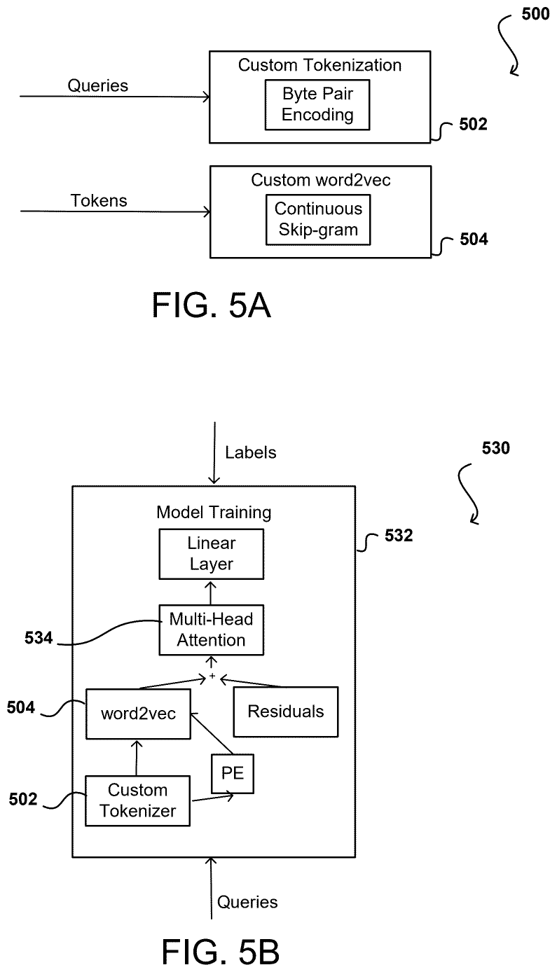

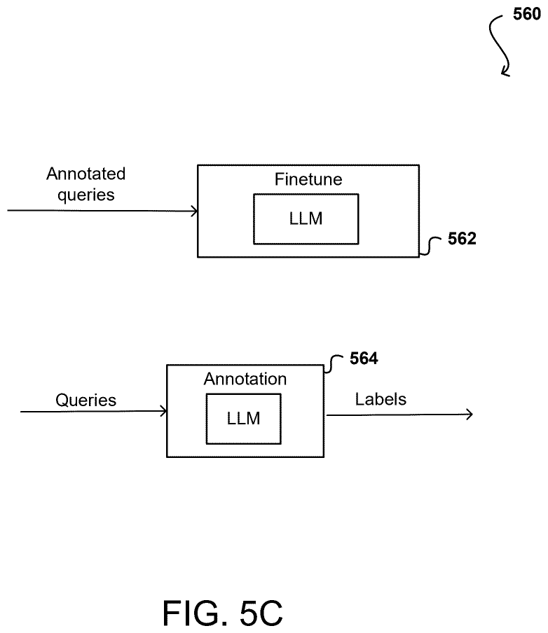

In another example approach to avoiding the need for use of an LLM, a classification head can be placed on top of traditional word embeddings (e.g., skip-gram or continuous bag of words (CBOW)). The knowledge of an LLM can be distilled into such a simpler model by first training a classifier on top of LLM embeddings, and then training the smaller model to follow the distribution of the output SoftMax layer of the LLM classifier. An advantage of such an approach is that it should naturally be fast, hence no additional efforts would likely be needed to reduce the latency. It may be possible to also fit some attention layers on top of traditional word embeddings, which may allow the model to gauge the varying importance of each word to the output within a context window. It may also be possible to alter a CBOW-based approach to provide learned attention to nearby words, instead of constant weights. In an example test case 500 as illustrated in FIG. 5A, a custom tokenizer 502 was first trained on CAP queries and a custom word2vec model 504 was trained using skip-gram on the custom tokens. A generic pretrained word2vec model was found to achieve inferior results. A custom trained model for cloud application programming (CAP) queries was observed to better capture semantic relationships between objects. In at least one embodiment, a tokenizer can be trained on a relevant dictionary, context, or data corpus. This may include, for example, a shopping data repository for an ecommerce site, where the vocabulary for offered items may come from the descriptions associated with those items. Such training can accept a term such as “king” and, instead of considering related terms such as “monarchy” or “castle” as might be determined to be related using a general dictionary, related terms might instead be “bed,” “duvet,” or “California,” which are terms related to king beds offered through the site. Retraining a tokenizer 502 on a relevant dataset or dictionary can help to improve the quality of the search.

FIG. 5B illustrates the use of the custom tokenizer 530 in a training module 532 of the view of FIG. 5B. As illustrated, the results of an intermediate layer (e.g., a SoftMax layer) are used for analysis rather than the final result of the final linear layer, in order to better capture the learnings of the LLM. As illustrated, multi-head attention 534 can be added on top of word2vec 504 and a shallow transformer-based classification network as the classification model. This model can then be trained on the data that was annotated (e.g., labeled) by the LLM through an annotation module 564, as illustrated in the view 560 of FIG. 5C, where the LLM was finetuned on annotated queries (with potentially high-quality hand-crafted data) using a finetuning (or other training) module 562, such as the training module 532 illustrated in FIG. 5B. Using such a pipeline and the architecture was observed to achieve over 75% accuracy for an inference time less than 0.5 milliseconds. To simplify data collection, an LLM can be used in the data collection flow. An LLM can then be finetuned for labeling a subset of queries from, for example, a CAP dataset.

Another way to help a user when the user types a detailed, visually descriptive query is to surface images from third party sources, such as images from social media sites or influencer pages. If a user is indeed looking for a trending item on social media, then the user might find that item on a set of influencer images that are surfaced. Such functionality can save a user (and computing resources for) the work of going to a different app, capturing a snapshot, and then uploading the snapshot. Such images can also be mined from various catalog or content repositories, or can be recommended based in part upon past observed user behavior.

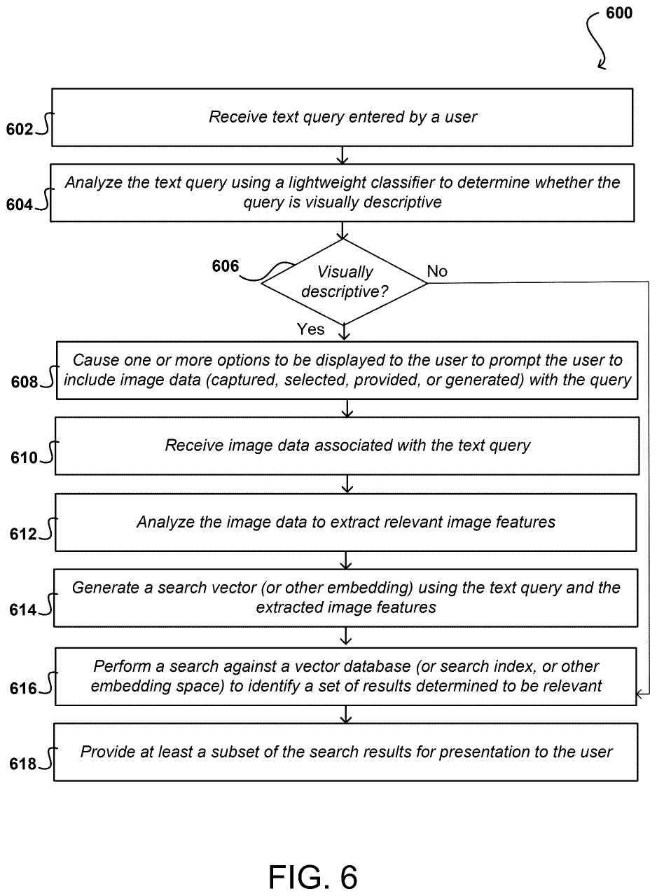

FIG. 6 illustrates an example process 600 that can be performed to allow for the use of image data with visually descriptive search queries, in accordance with at least one embodiment. It should be understood for this and other processes discussed and suggested herein that there can be additional, fewer, or alternative steps performed in similar or alternative orders, or at least partially in parallel, within the scope of the various embodiments unless otherwise specifically stated. Further, although discussed with respect to image data and visually descriptive queries, it should be understood that other types of queries may benefit from the inclusion of other modalities of information to be used for a search as discussed in more detail elsewhere herein. In this example, a text query (or at least a portion of a text query) is received 602 that was entered by a user or other such source. The entry could have been through typing, pasting, or another such approach. The text query can be analyzed 604 using a lightweight classifier to determine whether the text query is visually descriptive, or includes visually descriptive terms or intent. The lightweight classifier can be a model such as a transformer that was trained using training data generated by an LLM in at least one embodiment. A determination can be made 606 as to whether the query is visually descriptive. If not, the text query alone can be used to perform 616 a search, such as against a search index unless used to generate an encoded query that can be matched against a latent space or vector database, among other such options. In at least one embodiment, an LLM or similar language model can attempt to reformulate the query to obtain more relevant results based on, for example, knowledge of how the search index or vector database is built.

If, however, it is determined 606 that the query has at least a minimum (or threshold) probability of being visually descriptive, then one of more options can be caused 608 to be displayed to the user to prompt the user to include or provide image data with the text query. Other criteria may be used to make such a determination as well, such as whether a current category of search generally benefits from the inclusion of image data with a search query. The classifier can generate a probability or confidence score that the text query is visually descriptive, and that score can be compared against a confidence threshold to determine whether the query is likely visually descriptive, or may otherwise benefit from the inclusion of image (or other) data along with the text query. The options to be provided can include any appropriate options as discussed herein to provide image data, such as to capture or upload an image, select from a set of suggested images, or cause an image to be generated using a generative model, among other such options. If an image is provided along with the query, then the image data can be received 610, such as to a client device and/or a remote server. The image data can be analyzed 612, such as by using an encoder module, to extract relevant image (or descriptive) features. In some embodiments, a bounding box (or other boundary) around an object of interest can be determined, and image features extracted from only within that bounding box to improve relevancy. A search vector (or other embedding or query form) can be generated 614 using the text query and the extracted image features, such as by using a multi-modal model. As discussed, the query terms can be converted to vector form using an encoding model or word2vec module, among other such options. A search can then be performed 616 against the relevant content source, such as a vector database for a search vector, a search index for a text-based query, or a latent embedding space for another type of embedding, to identify a set of search results determined to be at least somewhat relevant or related. At least a subset of these search results can be provided 618 for presentation to the user. The user may select one or more of the search results, or may update the text query and/or image data to obtain new search results, among other such options. In at least some embodiments, a new set of search results can be returned for each significant change to the text query or image data, or other related aspect of the search. As mentioned, such a process can be used with various search options, as may be available through a web browser, mobile app, voice-recognition device, AI assistant, and the like. In at least one embodiment, such functionality can run anywhere autocomplete or similar functionality is (or may beneficially be) used.

As mentioned, there can be various determinations as to which images to suggest to a user for inclusion with a search query. In at least one embodiment, the system can present images of objects that are determined to most be related to the entered text query. In some embodiments, the presentation of images might be based at least more prominently on the objective words in the query, such as a type of object (e.g., couch or shoe). In some embodiments where the search is through an e-commerce site, the surfaced images may only be selected for items that the site actually sells. In some embodiments, images may be selected or featured that are related to the query but also “trending,” or currently popular on social media. There may be other filters or selection criteria used as well, as may be configurable by an authorized party.

In some instances, a user might enter a query that does not have any clear object type specified. For example, a user might enter a query such as “holiday decor.” Such a broad query may span multiple types of objects, with the relevant aspect being that they somehow visually convey a holiday. In such a situation, where there is no object specified, a prompt may be provided to associate image data with the query to help improve results. A selected image can help to specify which holiday, for example, which may also help to narrow the categories, as some holidays are associated with toys while others are associated with fireworks or costumes. For a “holiday decor” query, knowing the holiday can help to determine the types of decor to provide, such as whether to suggest holly wreaths or animatronic skeletons, each of which may only have relevance to specific holidays. If the user provides an image, that image can also help narrow the type of decor, such as whether to include table settings, ornaments, outdoor inflatables, and the like. In some embodiments, an image (or other additional content) prompt or suggestion may be provided any time a query is broad or unclear, or otherwise produces search results with less than a minimum confidence level. An image may also help to determine a style or type of decor, such as may correspond to color schemes, religious or non-religious imagery, and the like.

Various approaches can be used to perform multi-modal search. In one such approach, a dual-encoder architecture can be used, that is trained to align multiple input domains. Cross-aligning data in a multi-modal context has been observed to be highly effective in many instances. For data with multi-modal and/or multi-entity aspects, there may be two models used for at least an image matching portion. One example version is a 3-tower model (MIM-3-tower) based on CLIP, which is trained on the triples of {query image, object image, object description text}. Another version is a 4-tower model (MIM-4-tower), which adds one more text arm to accommodate a new short query text entity in the training data. Compared to the common uses of vision language models (e.g., for VQA, cross-model retrieval), these two models were observed to be highly accurate for various types of search.

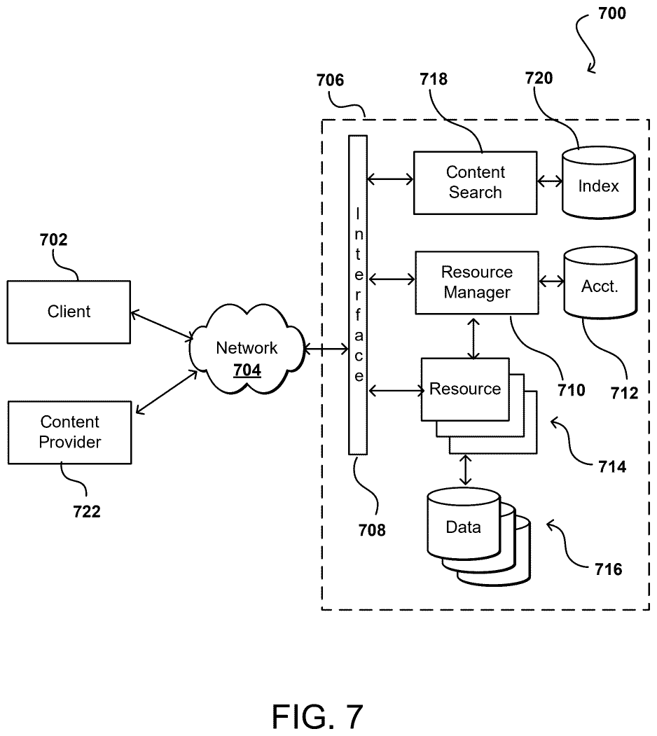

FIG. 7 illustrates an example environment 700 in which aspects of various embodiments can be implemented. Such an environment can be used in some embodiments to provide resource capacity for one or more users, or users of a resource provider, as part of a shared or multi-tenant resource environment. For example, the provider environment 706 can be a cloud environment that can be used to provide cloud-based network connectivity for users, as can be used during disaster recovery or network optimization. The resources can also provide networking functionality for one or more client devices 702, such as personal computers, which can be able to connect to one or more network(s) 704 or can be used to perform network optimization tasks as discussed herein.

In this example, a user is able to utilize a client device 702 to submit requests across at least one network 704 to a multi-tenant resource provider environment 706. The client device can include any appropriate electronic device operable to send and receive requests, messages, or other such information over an appropriate network and convey information back to a user of the device. Examples of such client devices include personal computers, tablet computers, smartphones, notebook computers, and the like. The at least one network 704 can include any appropriate network, including an intranet, the Internet, a cellular network, a local area network (LAN), or any other such network or combination, and communication over the network can be enabled via wired and/or wireless connections. The resource provider environment 706 can include any appropriate components for receiving requests and returning information or performing actions in response to those requests. As an example, the provider environment might include Web servers and/or application servers for receiving and processing requests, then returning data, Web pages, video, audio, or other such content or information in response to the request. The environment can be secured such that only authorized users have permission to access those resources.

In various embodiments, a provider environment 706 can include various types of resources that can be utilized by multiple users for a variety of different purposes. As used herein, computing and other electronic resources utilized in a network environment can be referred to as “network resources.” These can include, for example, servers, databases, load balancers, routers, and the like, which can perform tasks such as to receive, transmit, and/or process data and/or executable instructions. In at least some embodiments, all or a portion of a given resource or set of resources might be allocated to a particular user or allocated for a particular task, for at least a determined period of time. The sharing of these multi-tenant resources from a provider environment is often referred to as resource sharing, Web services, or “cloud computing,” among other such terms and depending upon the specific environment and/or implementation. In this example, the provider environment includes a plurality of resources 714 of one or more types. These types can include, for example, application servers operable to process instructions provided by a user or database servers operable to process data stored in one or more data stores 716 in response to a user request. As known for such purposes, a user can also reserve at least a portion of the data storage in a given data store. Methods for enabling a user to reserve various resources and resource instances are well known in the art, such that detailed description of the entire process, and explanation of all possible components, will not be discussed in detail herein.

In at least some embodiments, a user wanting to utilize a portion of the resources 714 can submit a request that is received to an interface layer 708 of the provider environment 706. The interface layer can include application programming interfaces (APIs) or other exposed interfaces enabling a user to submit requests to the provider environment. The interface layer 708 in this example can also include other components as well, such as at least one Web server, routing components, load balancers, and the like. When a request to provision a resource is received to the interface layer 708, information for the request can be directed to a resource manager 710 or other such system, service, or component configured to manage user accounts and information, resource provisioning and usage, and other such aspects. A resource manager 710 receiving the request can perform tasks such as to authenticate an identity of the user submitting the request, as well as to determine whether that user has an existing account with the resource provider, where the account data can be stored in at least one data store 712 in the provider environment. A user can provide any of various types of credentials in order to authenticate an identity of the user to the provider. These credentials can include, for example, a username and password pair, biometric data, a digital signature, a secure token, or other such information. The provider can validate this information against information stored for the user. If a user has an account with the appropriate permissions, status, etc., the resource manager can determine whether there are adequate resources available to suit the user's request, and if so can provision the resources or otherwise grant access to the corresponding portion of those resources for use by the user for an amount specified by the request. This amount can include, for example, capacity to process a single request or perform a single task, a specified period of time, or a recurring/renewable period, among other such values. If the user does not have a valid account with the provider, the user account does not enable access to the type of resources specified in the request, or another such reason is preventing the user from obtaining access to such resources, a communication can be sent to the user to enable the user to create or modify an account, or change the resources specified in the request, among other such options.

Once a user (or other requestor) is authenticated, the account verified, and the resources allocated, the user can utilize the allocated resource(s) for the specified capacity, amount of data transfer, period of time, or other such value. In at least some embodiments, a user might provide a session token or other such credentials with subsequent requests in order to enable those requests to be processed on that user session. The user can receive a resource identity, specific address, or other such information that can enable the client device 702 to communicate with an allocated resource without having to communicate with the resource manager 710, at least until such time as a relevant aspect of the user account changes, the user is no longer granted access to the resource, or another such aspect changes. In some embodiments, a user can run a host operating system on a physical resource, such as a server, which can provide that user with direct access to hardware and software on that server, providing near full access and control over that resource for at least a determined period of time. Access such as this is sometimes referred to as “bare metal” access as a user provisioned on that resource has access to the physical hardware.

A resource manager 710 (or another such system or service) in this example can also function as a virtual layer of hardware and software components that handles control functions in addition to management actions, as can include provisioning, scaling, replication, etc. The resource manager can utilize dedicated APIs in the interface layer 708, where each API can be provided to receive requests for at least one specific action to be performed with respect to the data environment, such as to provision, scale, clone, or hibernate an instance. Upon receiving a request to one of the APIs, a Web services portion of the interface layer can parse or otherwise analyze the request to determine the steps or actions needed to act on or process the call. For example, a Web service call might be received that includes a request to create a data repository.

An interface layer 708 in at least one embodiment includes a scalable set of user-facing servers that can provide the various APIs and return the appropriate responses based on the API specifications. The interface layer also can include at least one API service layer that in one embodiment consists of stateless, replicated servers which process the externally-facing user APIs. The interface layer can be responsible for Web service front end features such as authenticating users based on credentials, authorizing the user, throttling user requests to the API servers, validating user input, and marshalling or unmarshalling requests and responses. The API layer also can be responsible for reading and writing database configuration data to/from the administration data store, in response to the API calls. In many embodiments, the Web services layer and/or API service layer will be the only externally visible component, or the only component that is visible to, and accessible by, users of the control service. The servers of the Web services layer can be stateless and scaled horizontally as known in the art. API servers, as well as the persistent data store, can be spread across multiple data centers in a region, for example, such that the servers are resilient to single data center failures.

In at least one embodiment, a content search module 718 may be responsible for managing search requests submitted by a user, as may involve using search criteria to search against a search index 720 using a search engine. A text-based query can be received and analyzed by the content search module 718 to attempt to determine whether the query could benefit from an additional type of search information, such as where a visually descriptive text query might benefit from the addition of image data. If so, the content search module 718 can send instructions to the client device 702 to prompt a user, through a search interface, to provide such image information. The content search module 718 can then use this data (or features extracted from the image data) along with the text query to search for relevant content, then provide at least some of the most relevant search results for presentation to the user via the client device 702. In at least some embodiments, image data and/or search results may come from a third party content provider 722.

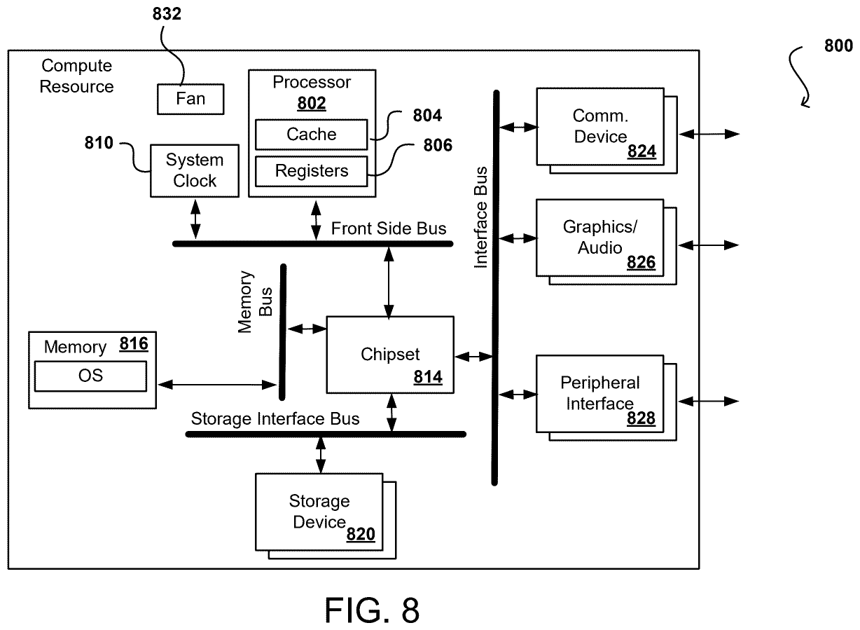

Computing resources, such as servers, routers, NICs, smartphones, or personal computers, will generally include at least a set of standard components configured for general purpose operation, although various proprietary components and configurations can be used as well within the scope of the various embodiments. As mentioned, this can include client devices for transmitting and receiving network communications, or servers for performing tasks such as network analysis and rerouting, among other such options. FIG. 8 illustrates components of an example computing resource 800 that can be utilized in accordance with various embodiments. It should be understood that there can be many such compute resources and many such components provided in various arrangements, such as in a local network or across the Internet or “cloud,” to provide compute resource capacity as discussed elsewhere herein. The computing resource 800 (e.g., a desktop or network server) will have one or more processors 802, such as central processing units (CPUs), graphics processing units (GPUs), and the like, that are electronically and/or communicatively coupled with various components using various buses, traces, and other such mechanisms. A system clock 810 may be used to provide a synchronizing reference signal to various components of the computing resource 800. A processor 802 can include memory registers 806 and cache memory 804 for holding instructions, data, and the like. In this example, a chipset 814, which can include a northbridge and southbridge in some embodiments, can work with the various system buses to connect the processor 802 to components such as memory 816, in the form or physical RAM or ROM, which can include the code for the operating system as well as various other instructions and data utilized for operation of the computing device. The computing device can also contain, or communicate with, one or more storage devices 820, such as hard drives, flash drives, optical storage, and the like, for persisting data and instructions similar, or in addition to, those stored in the processor and memory. The processor 802 can also communicate with various other components via the chipset 814 and an interface bus (or graphics bus, etc.), where those components can include communications devices 824 such as cellular modems or network cards, media components 826, such as graphics cards and audio components, and peripheral interfaces 828 for connecting peripheral devices, such as printers, keyboards, and the like. At least one cooling fan 832 or other such temperature regulating or reduction component can also be included as well, which can be driven by the processor or triggered by various other sensors or components on, or remote from, the device. Various other or alternative components and configurations can be utilized as well as known in the art for computing devices.

At least one processor 802 can obtain data from physical memory 816, such as a dynamic random access memory (DRAM) module, via a coherency fabric in some embodiments. It should be understood that various architectures can be utilized for such a computing device, which can include varying selections, numbers, and arguments of buses and bridges within the scope of the various embodiments. The data in memory can be managed and accessed by a memory controller, such as a DDR controller, through the coherency fabric. The data can be temporarily stored in a processor cache 804 in at least some embodiments. The computing resource 800 can also support multiple I/O devices using a set of I/O controllers connected via an I/O bus. There can be I/O controllers to support respective types of I/O devices, such as a universal serial bus (USB) device, data storage (e.g., flash or disk storage), a network card, a peripheral component interconnect express (PCIe) card or interface 828, a communication device 824, a graphics or audio card 826, and a direct memory access (DMA) card, among other such options. In some embodiments, components such as the processor, controllers, and caches can be configured on a single card, board, or chip (i.e., a system-on-chip implementation), while in other embodiments, at least some of the components can be located in different locations, etc.

An operating system (OS) running on the processor 802 can help to manage the various devices that can be utilized to provide input to be processed. This can include, for example, utilizing relevant device drivers to enable interaction with various I/O devices, where those devices can relate to data storage, device communications, user interfaces, and the like. The various I/O devices will typically connect via various device ports and communicate with the processor and other device components over one or more buses. There can be specific types of buses that provide for communications according to specific protocols, as can include peripheral component interconnect) PCI or small computer system interface (SCSI) communications, among other such options. Communications can occur using registers associated with the respective ports, including registers such as data-in and data-out registers. Communications can also occur using memory-mapped I/O, where a portion of the address space of a processor is mapped to a specific device, and data is written directly to, and from, that portion of the address space.

Such a device can be used, for example, as a server in a server farm or data warehouse. Server computers often have a need to perform tasks outside the environment of the CPU and main memory (i.e., RAM). For example, the server can need to communicate with external entities (e.g., other servers) or process data using an external processor (e.g., a General Purpose Graphical Processing Unit (GPGPU)). In such cases, the CPU can interface with one or more I/O devices. In some cases, these I/O devices can be special-purpose hardware designed to perform a specific role. For example, an Ethernet network interface controller (NIC) can be implemented as an application-specific integrated circuit (ASIC) comprising digital logic operable to send and receive packets.

In an illustrative embodiment, a host computing device is associated with various hardware components, software components and respective configurations that facilitate the execution of I/O requests. One such component is an I/O adapter that inputs and/or outputs data along a communication channel. In one aspect, the I/O adapter device can communicate as a standard bridge component for facilitating access between various physical and emulated components and a communication channel. In another aspect, the I/O adapter device can include embedded microprocessors to allow the I/O adapter device to execute computer executable instructions related to the implementation of management functions or the management of one or more such management functions, or to execute other computer executable instructions related to the implementation of the I/O adapter device. In some embodiments, the I/O adapter device can be implemented using multiple discrete hardware elements, such as multiple cards or other devices. A management controller can be configured in such a way to be electrically isolated from any other component in the host device other than the I/O adapter device. In some embodiments, the I/O adapter device is attached externally to the host device. In some embodiments, the I/O adapter device is internally integrated into the host device. Also in communication with the I/O adapter device can be an external communication port component for establishing communication channels between the host device and one or more network-based services or other network-attached or direct-attached computing devices. Illustratively, the external communication port component can correspond to a network switch, sometimes known as a Top of Rack (“TOR”) switch. The I/O adapter device can utilize the external communication port component to maintain communication channels between one or more services and the host device, such as health check services, financial services, and the like.

The I/O adapter device can also be in communication with a Basic Input/Output System (BIOS) component. The BIOS component can include non-transitory executable code, often referred to as firmware, which can be executed by one or more processors and used to cause components of the host device to initialize and identify system devices such as the video display card, keyboard and mouse, hard disk drive, optical disk drive and other hardware. The BIOS component can also include or locate boot loader software that will be utilized to boot the host device. For example, in one embodiment, the BIOS component can include executable code that, when executed by a processor, causes the host device to attempt to locate Preboot Execution Environment (PXE) boot software. Additionally, the BIOS component can include or take the benefit of a hardware latch that is electrically controlled by the I/O adapter device. The hardware latch can restrict access to one or more aspects of the BIOS component, such as controlling modifications or configurations of the executable code maintained in the BIOS component. The BIOS component can be connected to (or in communication with) a number of additional computing device components, such as processors, memory, and the like. In one embodiment, such computing device resource components can be physical computing device resources in communication with other components via the communication channel. The communication channel can correspond to one or more communication buses, such as a shared bus (e.g., a front side bus, a memory bus), a point-to-point bus such as a PCI or PCI Express bus, etc., in which the components of the bare metal host device communicate. Other types of communication channels, communication media, communication buses or communication protocols (e.g., the Ethernet communication protocol) can also be utilized. Additionally, in other embodiments, one or more of the computing device resource components can be virtualized hardware components emulated by the host device. In such embodiments, the I/O adapter device can implement a management process in which a host device is configured with physical or emulated hardware components based on a variety of criteria. The computing device resource components can be in communication with the I/O adapter device via the communication channel. In addition, a communication channel can connect a PCI Express device to a CPU via a northbridge or host bridge, among other such options.

In communication with the I/O adapter device via the communication channel can be one or more controller components for managing hard drives or other forms of memory. An example of a controller component can be a SATA hard drive controller. Similar to the BIOS component, the controller components can include or take the benefit of a hardware latch that is electrically controlled by the I/O adapter device. The hardware latch can restrict access to one or more aspects of the controller component. Illustratively, the hardware latches can be controlled together or independently. For example, the I/O adapter device can selectively close a hardware latch for one or more components based on a trust level associated with a particular user. In another example, the I/O adapter device can selectively close a hardware latch for one or more components based on a trust level associated with an author or distributor of the executable code to be executed by the I/O adapter device. In a further example, the I/O adapter device can selectively close a hardware latch for one or more components based on a trust level associated with the component itself. The host device can also include additional components that are in communication with one or more of the illustrative components associated with the host device. Such components can include devices, such as one or more controllers in combination with one or more peripheral devices, such as hard disks or other storage devices. Additionally, the additional components of the host device can include another set of peripheral devices, such as Graphics Processing Units (“GPUs”). The peripheral devices and can also be associated with hardware latches for restricting access to one or more aspects of the component. As mentioned above, in one embodiment, the hardware latches can be controlled together or independently.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions (including microcode), data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes can be made thereunto without departing from the broader spirit and scope of the invention as set forth in the claims.

1. A computer-implemented method, comprising:
receiving a text query, provided by a user through a client device, to locate content associated with an object of interest;
analyzing, using a classifier model, the text query to determine a confidence score corresponding to whether the text query includes visually descriptive terminology; and
in response to determining that the confidence score exceeds a confidence threshold that the text query includes visually descriptive terminology:
determining, using the classifier model, a set of suggested images that at least partially match the text query;
causing one or more options from the set of suggested images to be presented on the client device that prompt the user to provide, select, or generate image data including a representation of the object of interest;
receiving the image data via the one or more options;
analyzing the image data to extract image features associated with the object of interest represented in the image data;
performing a search against a content repository using the text query and the extracted image features; and
providing at least a subset of highest-ranked search results for presentation via the client device.

2. The computer-implemented method of claim 1, wherein the classifier model is a lightweight transformer model trained using training data annotated by a large language model (LLM).

3. The computer-implemented method of claim 1, wherein the one or more options include at least one graphical element allowing a user to capture at least one image or video using a camera, upload at least one pre-existing image or video, select at least one of a set of recommended images, or generate an image using a generative artificial intelligence (AI) model based in part on the text query.

4. The computer-implemented method of claim 1, further comprising:
encoding the extracted image features and the text query into at least one search vector; and
performing the search, using the at least one search vector, against a vector database.

5. The computer-implemented method of claim 1, further comprising:
encoding the extracted image features and the text query as at least one point in a latent space; and
identifying and ranking the search results based in part upon a proximity in the latent space.

6. A computer-implemented method, comprising:
determining, using a classifier model, a confidence score corresponding to whether a received text-based search query includes visually descriptive terminology;
in response to determining that the confidence score exceeds a confidence threshold that the received text-based search query includes visually descriptive terminology:
determining, using the classifier model, a set of suggested images that at least partially match the received text-based search query; and
causing one or more options from the set of suggested images to be presented to prompt at least one of a providing, a generation, or a selection of image data corresponding to the received text-based search query; and
performing a multi-modal search based in part on the text-based search query and the image data.

7. The computer-implemented method of claim 6, further comprising:
determining that the text-based search query is of a type that could benefit from a multi-modal search independent of an inclusion of visually descriptive technology; and
causing the one or more options to be presented to prompt inclusion of image data with the text-based search query.

8. The computer-implemented method of claim 7, wherein determining that the text-based search query is of a type that could benefit from a multi-modal search includes determining that the text-based search query was pasted in from another source, is over a threshold length, or includes subjective or perceptive terminology.

9. The computer-implemented method of claim 6, further comprising:
causing one or more options to be presented to prompt at least one of a providing, a generation, or a selection of additional data of a type other than image data or a text-based search query; and
performing the multi-modal search based further on the additional data.

10. The computer-implemented method of claim 6, wherein the classifier model is a lightweight transformer model trained using training data annotated by a large language model (LLM).

11. The computer-implemented method of claim 10, wherein the lightweight transformer model is trained using values associated with an intermediate layer of the LLM.

12. The computer-implemented method of claim 6, wherein the one or more options include at least one graphical element allowing a user to capture at least one image or video using a camera, upload at least one pre-existing image or video, select at least one of a set of recommended images, or generate an image using a generative artificial intelligence (AI) model based in part on the text-based search query.

13. The computer-implemented method of claim 12, further comprising:
using a generative AI model to generate the image data based in part on the text-based search query; and
updating, using the generative AI model, the image data in response to one or more modifications to the text-based search query.

14. The computer-implemented method of claim 6, further comprising:
finetuning a tokenizer, to be used in model training, using a vocabulary associated with a corpus to be searched.

15. The computer-implemented method of claim 6, further comprising:
extracting, from the image data, image features determined to be associated with a primary object in the image data.

16. The computer-implemented method of claim 6, further comprising:
allowing a user to select a different object represented in the image data from which to extract image features to be used for the multi-modal search.

17. A system, comprising:
at least one processor; and
a memory device including instructions that, when executed by the processor, cause the processor to:
analyze a received text-based search query to determine a confidence score corresponding to whether the received text-based search query is of a type that could benefit from at least one additional type of data;
in response to determining that the confidence score exceeds a confidence threshold that the received text-based search query is of the type that could benefit from at least one additional type of data:
determine, using the classifier model, a set of suggested images that at least partially match the received text-based search query; and
cause one or more options from the set of suggested images to be presented to prompt for association of the at least one additional type of data with the received text-based search query; and
perform a multi-modal search based in part on the received text-based search query and the at least one additional type of data.

18. The system of claim 17, wherein determining that the text-based search query is of a type that could benefit from at least one additional type of data includes determining that the text-based search query includes visually descriptive technology.

19. The system of claim 17, wherein determining that the text-based search query is of a type that could benefit from at least one additional type of data includes determining that the text-based search query was pasted in from another source, is over a threshold length, or includes subjective or perceptive terminology.

20. The system of claim 17, wherein a classifier model that analyzes the received text-based search query is a lightweight transformer model trained using training data annotated by a large language model (LLM).
